(19) United States
(12) Patent Application Publication
(10) Pub. No.: US 2009/0183952 A1
(43) Pub. Date: Jul. 23, 2009

(54) Automotive lifting arm sleeve

(76) Inventor: James R. Alford, Lafayette, IN (US)

Correspondence Address: DOWELL BAKER, P.C., 201 MAIN STREET, SUITE 710, LAFAYETTE, IN, 47901, US

(21) Appl. No.: 12/009,430

(22) Filed: Jan. 18, 2008

(51) Int. Cl. B66F 7/28

(52) U.S. Cl. 187/203; 187/204

(57) ABSTRACT

A padded sleeve made from a durable and resilient material, capable of being secured to an automobile lifting arm. The padded sleeve is removable, yet securely attachable so that it remains in place during use. The sleeve includes a rubber grip that covers the top of the automotive lifting arm, providing a tactile surface for secure footing on top of the lifting arm.

### FIELD OF THE INVENTION

This invention generally relates to padded sleeves for vehicle lifting arms. The invention disclosed is a removable cushioned sleeve that provides a number of useful benefits to mechanics or technicians working on a vehicle utilizing an automobile lift system.

### BACKGROUND OF THE INVENTION

It is a common practice in the automotive servicing field for a mechanic or technician to utilize an automotive lift system to raise an automobile off the ground allowing the technician to complete repairs underneath the vehicle. Automotive lift systems have various configurations, but often include four lifting arms (two on each side of the vehicle) which support the vehicle by lifting the frame of the vehicle off the ground so that the technician can walk underneath the car. Typically, the lifting arms support the vehicle in four locations, two of the arms lifting behind the front wheels and two of the arms lifting in front of the back wheels.

One common automotive lift has two upright columns, each column including two lifting arms that extend horizontally from the columns to support a vehicle. The lifting arms are generally adjustable, so as to accommodate a wide variety of vehicles. The technician or mechanic will adjust the lifting arms to extend to the proper locations underneath the vehicle. It is important for the vehicle to be properly secured to the lift allowing the technician to work safely underneath the vehicle. With some automotive lifts, the adjustment of the lifting arms requires the technician to use force to maneuver the arms into the appropriate position. Generally, the lifting arms have a powder-coated finish, providing a smooth or slick surface, which facilitates the movement of the lifting arms into the proper extension and position. However, when a lifting arm becomes wet, for example, on rainy days, water will fall off of the vehicle onto a lifting arm creating a slipping hazard. Technicians often step on a lifting arm to gain access to the inside of the vehicle. If the lifting arm is wet, the combination of the smooth lifting arm surface with water may cause the technician to slip or fall.

The automotive lift system poses another hazard. The automotive lifting arms that raise the vehicle off the ground are made of steel and it is not uncommon for a mechanic or technician to bump his or her head on a steel lifting arm often resulting in concussions or lacerations to the head. At least one patent has attempted to address this issue. U.S. Pat. No. 7,267,199 (incorporated herein by reference) provides padded end caps for the end of automotive lifting arms. Although these padded caps provide some protection from the end of the lifting arm, the padded caps cover only a minimal portion of the lifting arm. Also, the padded caps are secured by an adhesive and therefore, are not removable for cleaning. Further, the '199 patent end caps are susceptible to falling off of the lifting arms when the technicians maneuver the lifting arms to the appropriate locations underneath a vehicle. Finally, on some styles of automotive lifts, the padded end caps drag on the ground. Accordingly, a padded lifting arm cover is needed that overcomes these and other problems known in the art.

Therefore, an object of the present invention is to provide a protective padded cover for automotive lifting arms that is secured to the lifting arm and remains secure when the lifting arms are moved into an operable position.

Another object of the invention is to provide a surface on the top of the lifting arms that provides secure footing and minimizes the slipping caused by moisture on the lifting arms.

A further object of the invention is to provide a material to cover the lifting arms that does not rip easily, that can withstand a significant amount of contact or stress and that is resilient to the chemicals and fluids normally associated with automobiles.

Yet another object of the invention is to provide a cushioning device for the lifting arms that can be easily removed, cleaned and reattached to the lifting arm.

Another object of the invention is to provide a padded sleeve that covers a greater portion of the lifting arm than merely the end of the lifting arm.

Furthermore, an object of the invention is to provide a padded sleeve that covers both the end of the lifting arm and the portion of the lifting arm where the larger tubing adjoins the smaller tubing.

A further object of the invention is to provide a padded sleeve that can fit multiple types and styles of lifting arms.

Still another object of the invention is to provide an affordable lifting arm cover that is easily produced.

Finally, it is an object of the invention to provide a padded sleeve that does not drag on the ground when connected to various lifting arms.

### SUMMARY OF THE INVENTION

The preferred embodiment of the present invention provides a padded sleeve for covering an automotive lifting arm. The padded sleeve is secured to the automotive lifting arm covering both the end of the lifting arm and the section of the lifting arm where the larger tubing adjoins the smaller tubing. The sleeve is made from a durable and resilient material and is secured to the lifting arm so that it does not shift during use, but is also removable. The sleeve can be cleaned and reattached to the lifting arm. The sleeve includes a rubber grip that covers the top of the automotive lifting arm, to prevent slipping when the lifting arm is stepped upon to gain access to the interior of a vehicle.

### BRIEF DESCRIPTION OF THE DRAWINGS

FIG. 1 is a perspective view of the outside of the padded sleeve stretched out and unattached to an automotive lifting arm.

FIG. 2 is a perspective view of the rubber grip that covers the top of the sleeve.

FIG. 3 is a perspective view of the outside of the padded sleeve and the rubber grip together, showing the sleeve's ability to mold or conform to the shape of an automotive lifting arm.

FIG. 4 is a perspective view of the padded sleeve wherein the rubber grip is secured to the upper portion of the sleeve covering an automotive lifting arm.

FIG. 5 is a perspective view of an automotive lift system showing three of the lifting arms covered with the padded sleeve and one lifting arm not covered by a padded sleeve.

### DETAILED DESCRIPTION OF THE INVENTION

The present invention may be used with a wide variety of vehicle lifting arms, but those of skill in the art will recognize that the present invention is equally adaptable for use with other lifts where an individual works underneath the lift. For descriptive purposes, the present invention will be described as used on an automotive lifting arm.

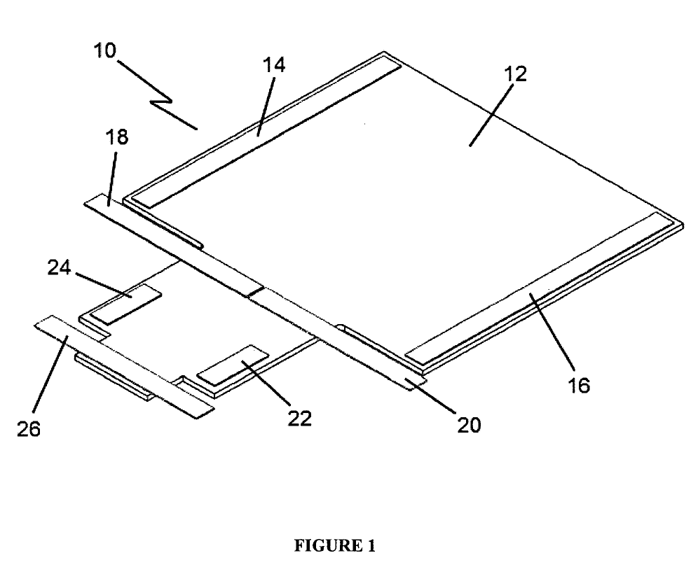

FIG. 1 shows the outside of a wrap or sleeve 10 of the present invention unattached to any automotive lifting arm. In the preferred embodiment, the sleeve 10 is cut from a single sheet of closed cell foam. One of ordinary skill in the art will recognize that it is not necessary that the sleeve be cut from a single sheet of foam, however, for cost and durability considerations, this is desirable. Furthermore, the sleeve 10 may be produced utilizing any resilient material that provides a cushioned or padded surface.

In the preferred embodiment the sleeve 10 is made from an expanded closed cell foam that is mold resistant. The sleeve must be strong enough to avoid tearing when the lifting arms are pushed and pulled as the arms are moved into the appropriate position each time a different vehicle is placed on the automotive lift. The foam for the sleeve must also be sufficiently flexible so that it wraps securely around the lifting arm, allowing the sleeve to conform to many different types of the lifting arms. Furthermore, the foam 12 must be thick enough to provide sufficient padding to protect against head injuries, but thin enough to allow the foam to wrap around the lifting arm without interfering with the utility of the lifting arm.

As shown in FIG. 1 the foam padding 12 of the sleeve 10 includes a large rectangular portion which narrows to a smaller rectangular portion, which narrows further to a third rectangular portion. Other shapes may be utilized depending upon the shape and size of the automotive lift arm to be fitted. The size and shape shown in FIG. 1 is desirable as it provides a customized fit that can conform to most automotive lifting arms.

FIG. 1 also shows the location of seven hook and fastener straps. Straps 14 and 16 are offset from the edge of the pad and run parallel to the longitudinal axis of the sleeve 10. Similarly, straps 22 and 24 also run parallel to the longitudinal axis of the sleeve, but are located on the smaller rectangular portion of the open sleeve. Straps 18 and 20 are also located on this smaller rectangular portion of the open sleeve 10, however, straps 18 and 20 are oriented perpendicular to the longitudinal axis or parallel to the transverse axis of the open sleeve 10. Strap 26 is located at the end of the smallest rectangular portion of the open sleeve 10 or the end portion of the sleeve 10. Strap 26 is also aligned parallel to the transverse axis of the open sleeve 10.

The inventor has found that utilizing hook and fastener straps allows the sleeve to adapt to different sizes and types of lifts. It is important that the sleeve remain secure to the lifting arm as the technicians often pull and push the sleeve when adjusting the lifting arms for each new vehicle that is placed on the lift. Additional features such as suction cups or high performance rubber may be incorporated to assist in securing the sleeve to the lifting arms. Although hook and fastener straps are preferred, it should be understood that the number of straps and the method of wrapping the straps may differ from those illustrated in the figures. For example, ratcheting connectors or the like, may be utilized to secure the straps together.

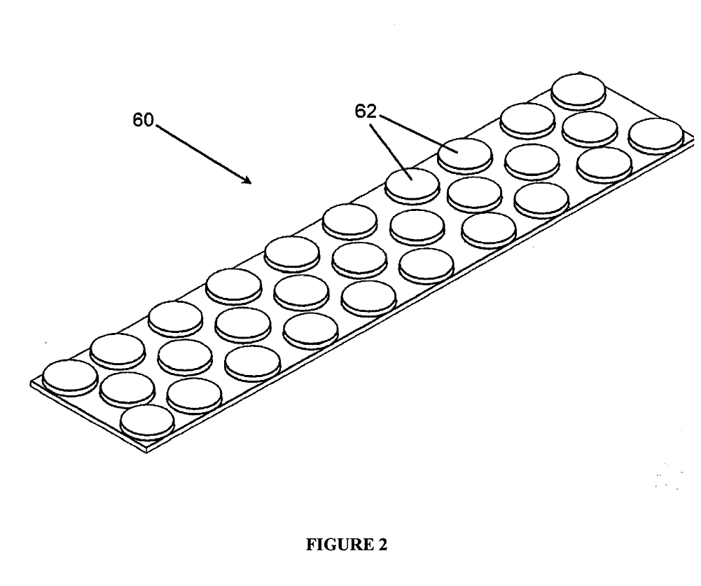

FIG. 2 shows a rubber grip 60 that secures the sleeve 10 over the top of the vehicle lifting arm. The round protrusions 62 provide a tactile surface for secure footing, preventing a technician from slipping when the lifting arm is stepped upon by a technician trying to enter a vehicle secured to an automotive lift. The rubber grip 60 provides safer footing than the bare metal or powder-coated lifting arm, especially when the arm is wet. Not shown, but present underneath the rubber grip 60 is hook and loop fastener straps for connecting to the top portions of the sleeve 10 in its operative position.

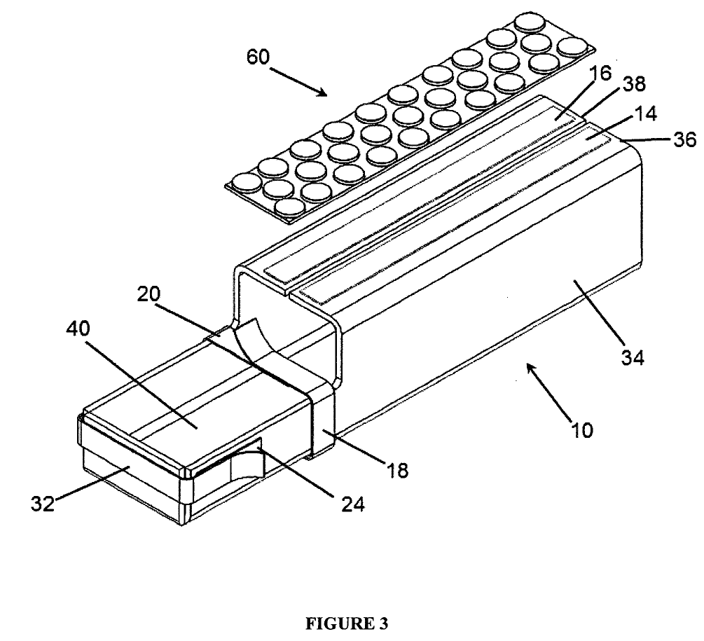

FIG. 3 shows the wrap or sleeve's ability to conform to the shape of an automotive lifting arm. The flexibility of the pad allows it to be folded to form a bottom portion, side portions, top portions and an end portion. FIG. 3 shows the end portion 32 folded vertically to form the end of the sleeve. Side portion 34 is also folded vertically allowing strap 26 to connect to strap 24 (likewise, strap 22, not shown, is connected to strap 26) allowing the sleeve to conform to a tubular shape. The side portions are also held into place by straps 18 and 20. Top portions 36 and 38 are also folded to form the top portions of the sleeve 10. Once the top portions 36 and 38 are properly positioned, the rubber grip 60 may be secured to the straps 14 and 16 to conform the sleeve 10 to a tube-like shape.

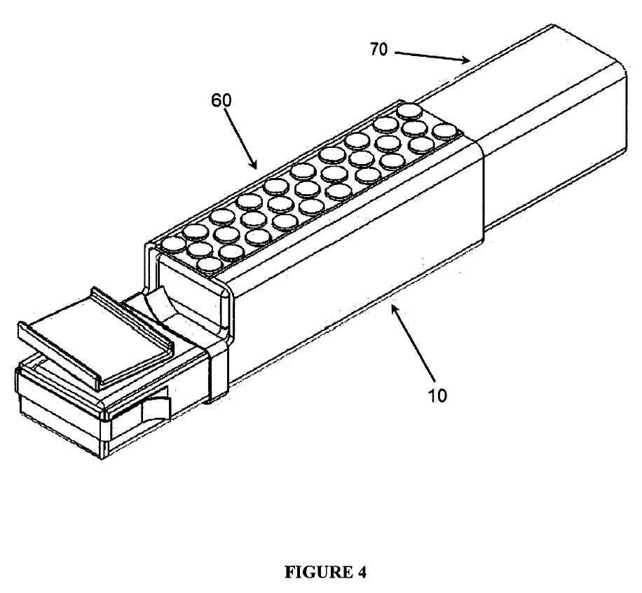

FIG. 4 shows the sleeve 10 completely secured to a lifting arm 70, with the rubber grip 60 secured to the top portions 36 and 38 of the sleeve 10. The rubber grip 60 secures the top of the sleeve 10 to the lifting arm 70, but does not cover the portion of the lifting arm that attaches or secures the lifting arm to a vehicle. FIG. 4 shows how the sleeve 10 conforms to the shape of the lifting arm providing a protective cover without limiting the functionality of the lifting arm.

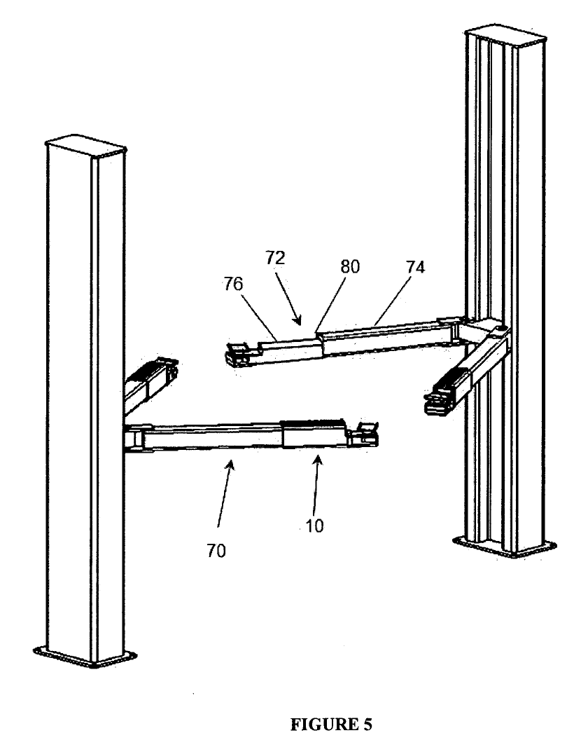

FIG. 5 shows an automotive lift system with four lifting arms 70. Three of the lifting arms are covered by the sleeve 10 and one lifting arm is uncovered as it does not include the sleeve. The uncovered lifting arm 72 shows how the lifting arms often include a section of larger tubing 74 accepting a section of smaller tubing 76, allowing the arms to be extended and retracted. The location 80 where the larger tubing 74 meets the smaller tubing 76 is another location (the end of the lifting arm being the primary location) where technicians often bump their head, sometimes causing concussions or lacerations. As shown on the three covered lifting arms, the sleeve 10 covers the junction 80 of the larger and smaller tubing providing protection to the technician from this additional area for head injuries.

The preferred embodiment uses hook and loop fasteners to secure the sleeve to an automotive lifting arm, allowing the sleeve to be attached to multiple types and sizes of automotive lifting arms. Furthermore, using hook and loop fasteners, allows easy removal, cleaning and reattachment of the sleeve. As is known in the art, many other ways of securing the sleeve may be used, such as adhesives, stitching, magnets and other means.

Other alterations, variations and combinations are possible that fall within the scope of the present invention. Although the preferred embodiments of the present invention have been described, those skilled in the art will recognize other modifications that may be made that would nonetheless fall within the scope of the present invention. Therefore, the present invention should not be limited to the apparatus described. Instead, the scope of the present invention should be consistent with the invention claimed below.

I claim:

1. A padded sleeve for covering an automotive lifting arm comprising:
a flexible body of resilient material, a bottom portion, a first side portion, a second side portion, at least one top portion, an end portion; and
means for attaching the sleeve to the automotive lifting arm.

2. The sleeve of claim 1 wherein the sleeve includes a tactile surface on the top portion of the sleeve.

3. The sleeve of claim 2 wherein the top portion of the sleeve covers a portion of the top of the lifting arm.

4. The sleeve of claim 2, wherein the sleeve includes a means for removing and reattaching the sleeve to a lifting arm.

5. The sleeve of claim 1, further comprising the first side portion having
a bottom edge proximal to the bottom portion;
an end edge proximal to the end portion, the end edge connecting to the bottom edge;
a middle horizontal edge substantially parallel to the bottom edge, the middle horizontal edge connecting to the end edge;
a middle vertical edge substantially parallel to the end edge, the middle vertical edge connecting to the middle horizontal edge; and
a top edge connecting to the middle vertical edge, the top edge substantially parallel to the middle horizontal edge.

6. The sleeve of claim 5 further comprising the first side portion having a junction edge connecting to the top edge and the bottom edge, the length of the junction edge greater than the length of the end edge.

7. The sleeve of claim 6 further comprising the bottom edge having a length greater than the individual lengths of the end edge, the middle horizontal edge, the middle vertical edge, and the top edge.

8. The sleeve of claim 5 further comprising an end fastener secured to the first side portion between the middle vertical edge and the bottom edge, the end fastener further connecting to the end portion.

9. A padded sleeve for covering an automotive lifting arm, wherein the lifting arm includes a larger section of tubing connected to a smaller section of tubing, the padded sleeve comprising:
a body of resilient material, an end portion, two side portions, at least one top portion,
the end portion connecting to the body, the two side portions connecting to the body and the at least one top portion connected to a side portion.
wherein at least a portion of the sleeve covers both the larger section of tubing and the smaller section of tubing; and
a fastener for attaching the sleeve to the automotive lifting arm.

10. The sleeve of claim 9 wherein the sleeve includes a tactile surface on the top portion of the sleeve.

11. The sleeve of claim 9 wherein the body of resilient material is flexible.

12. The sleeve of claim 11 further comprising an end fastener connecting the end portion to the two side portions.

13. The sleeve of claim 9 further comprising the first side portion having
a bottom edge;
a end edge proximal to the end portion, the end edge connecting to the bottom edge;
a middle horizontal edge substantially parallel to the bottom edge, the middle horizontal edge connecting to the end edge;
a middle vertical edge substantially parallel to the end edge, the middle vertical edge connecting to the middle horizontal edge; and
a top edge connecting to the middle vertical edge, the top edge substantially parallel to the middle horizontal edge.

14. A cushioned wrap for covering an automotive lifting arm comprising:
a body of resilient material, wherein the material touching the automotive lifting arm comprises the inside of the wrap and the material not touching the automotive lifting arm comprises the outside of the wrap;
wherein, the outside of the wrap includes a tactile section; and
means for attaching the wrap to the automotive lifting arm.

15. The wrap of claim 14, wherein the body of resilient material is flexible.

16. The wrap of claim 15, wherein the means for attaching the wrap to the automotive lifting arm is a hook and loop fasteners.
